(19) United States
(12) Patent Application Publication
(10) Pub. No.: US 2020/0359481 A1
(43) Pub. Date: Nov. 12, 2020

(54) OPERATING CIRCUIT AND METHOD FOR OPERATING AT LEAST ONE ILLUMINANT

(71) Applicant: PANASONIC INTELLECTUAL PROPERTY MANAGEMENT CO., LTD., Osaka-shi, Osaka (JP)

(72) Inventors: Elmar HINRICHS, Urbach (DE); Michael KOLB, Schwäbisch Gmünd (DE)

(73) Assignee: Panasonic Intellectual Property Management Co., Ltd., Osaka-shi, Osaka (JP)

(21) Appl. No.: 16/095,198

(22) PCT Filed: Apr. 21, 2017
(86) PCT No.: PCT/JP2017/015999

§ 371 Date: Oct. 19, 2018

(30) Foreign Application Priority Data
Apr. 25, 2016 (DE) 10 2016 107 578.7

(51) Int. Cl. H05B 45/3725; H05B 45/14; H05B 45/325

(52) U.S. Cl. CPC H05B 45/3725; H05B 45/325; H05B 45/14

(57) ABSTRACT

An operating circuit has a supply circuit that is connected to a supply voltage and that has a first converter circuit. The supply circuit is connected to a power stage through an intermediate circuit with an energy storage to buffer an intermediate circuit voltage. The power stage has a second converter circuit. The output side of the power stage has the at least one illuminant connected to it. A desired dimming level is specified through a dimming input signal. Depending on the dimming input signal, the power stage is actuated by means of a dimming control signal to adjust the lighting power. The dimming control signal or a signal characterizing the dimming control signal is taken into consideration in the controller of the supply circuit, to keep the intermediate circuit voltage within a specified voltage range.

### TECHNICAL FIELD

The invention relates to an operating circuit and a method (a process) for operating at least one illuminant. The illuminant is, in particular, a semiconductor illuminant, for example a light-emitting diode.

### BACKGROUND ART

Operating circuits with current regulators or voltage regulators to operate illuminants have, for example, one or more converters to provide the lighting power for the at least one illuminant. It is frequently required that the lighting power must be adjustable through a dimmer.

DE 10 2010 031 845 A1 describes an operating circuit for light-emitting diodes, the operating circuit having a converter with a switch that simultaneously serves to dim the light-emitting diodes. This makes it possible to dispense with an actuable dimmer switch that is additionally connected in series with the light-emitting diodes. During an active phase established by the dimming signal, the converter switch is alternately switched over between its conducting and its blocking state and then kept in the blocking state during a passive phase. A similar operating circuit is also disclosed in EP 1576858 B1.

In such dimmable converters, flickering of the light-emitting diodes can occur. To avoid flickering, DE 11 2013 002933 T5 proposes lowering a threshold limiting the current through a coil of the converter or the light-emitting diodes at the beginning of the passive phase, that is at the end of the preceding active phase. The reason for this is that too much current flows through the light-emitting diodes in the transition from the active phase to the passive phase, which could cause an optically perceptible flickering. This threshold is raised back to its original value before the beginning of the next active phase.

DE 10 2010 031239 A1 discloses an operating circuit in which two converters are coupled through an intermediate circuit. The intermediate circuit voltage at the output of the first converter is variably adjusted depending on the electrical power that the other converter provides for the light-emitting diodes.

In order to achieve low electrical powers or low lighting powers of a light-emitting diode, DE 10 2013 216 877 A1 provides that the turn-on time of a switched mode electronic converter is further reduced when the power falls below a power threshold, unlike what is usual with pulse-width modulation. Instead, the duration of the turn-on time is kept constant below the power threshold, and only the duration of the turn-off time of the pulse-width modulated signal is increased. Thus, in a power range up to the power threshold the duty cycle of the pulse-width modulated signal is adapted by changing the switching frequency while the duration of the turn-on time remains constant.

EP 2 723 146 A1 describes a DC-DC converter that is operated not at a constant converter frequency, but rather at a continuously changing converter frequency. To accomplish this, a ramp generator is used to produce a ramp signal, and the converter frequency is changed depending on the magnitude of the ramp signal. The ramp signal is synchronized with a pulse-width modulated dimming signal to actuate a dimmer switch connected in series with the light-emitting diodes. The ramp is reset either with a rising flank or a falling flank of the pulse-width modulated dimming signal. This is intended to improve the electromagnetic compatibility of the operating circuit.

### CITATION LIST

### Patent Literature

[PTL 1] DE 10 2010 031 845 A1

[PTL 2] EP 1576858 B1

[PTL 3] DE 11 2013 002933 T5

[PTL 4] DE 10 2010 031239 A1

[PTL 5] DE 10 2013 216 877 A1

[PTL 6] EP 2 723 146 A1

### SUMMARY OF INVENTION

### Technical Problem

Starting from known operating circuits and methods, the goal of the invention can be considered to be to create an operating circuit and a method for operating illuminants that makes it simple to avoid the flickering of the illuminants.

### Solution to Problem

This is accomplished by an operating circuit having the features of claim 1 and a method having the features of claim 15.

The operating circuit or method serves to operate at least one illuminant, in particular a semiconductor illuminant, for example at least one light-emitting diode. If multiple illuminants are provided, they can be connected with one another in series and/or in parallel.

The operating circuit has a supply circuit that has an input for connection to a supply voltage, for example a line voltage. The input of the supply circuit can be connected with the line voltage indirectly, through a rectifier and/or a filter. The supply circuit has an actuable first converter circuit with a first converter switch, or is formed by the first converter circuit. In a preferred sample embodiment, the supply circuit can be set up to carry out a power factor correction (PFC).

An output of the supply circuit has an intermediate circuit connected to it. The intermediate circuit connects the output of the supply circuit with an input of a power stage. The intermediate circuit has energy storage, for example a capacitor, to which is applied an intermediate circuit voltage, which is buffered for the power stage.

The output side of the power stage has the at least one illuminant connected to it. In one sample embodiment, an actuable dimmer switch can be provided in series with the at least one illuminant. The power stage provides the electrical power for the at least one illuminant. If one or more light-emitting diodes are used as illuminants, it is preferable for the power stage to serve as the current source, in particular a constant current source. The power stage has a second converter circuit with an actuable second converter switch.

The operating circuit also includes a dimmer controller. The dimmer controller receives a dimming input signal that can be adjusted, for example by an operator, to specify a dimming level. The dimmer controller is set up to produce a pulse-width modulated dimming control signal depending on the dimming input signal. The dimming control signal has a specified dimming frequency. The dimming frequency is preferably greater than the line frequency (50 or 60 Hz) of an alternating voltage network, e.g., by about a factor of 5. The lighting power in the power stage is adjusted by means of the dimming control signal. The pulse-width modulated dimming control signal defines an active phase of the power stage and a passive phase of the power stage through the duty cycle. During the passive phase, no electrical power is output, at the output of the power stage, to the at least one illuminant.

The operating circuit also has a supply controller that receives the dimming control signal. The supply controller controls the supply circuit's energy or power output to the intermediate circuit. The supply controller sends a pulse-width modulated supply control signal to the supply circuit to specify the energy or power output to the intermediate circuit. The pulse-width modulated supply control signal has a first converter frequency that is independent of the dimming frequency of the dimming control signal. The first converter frequency is preferably greater than the dimming frequency, e.g., by a factor of 30. The supply control signal defines an active phase and a passive phase of the supply circuit. During the active phase, an electrical power is output to the intermediate circuit. During the passive phase, no power is output to the intermediate circuit. During the active phase of the supply circuit, the first converter switch is switched over, at a converter frequency, between a conducting and a blocking state. During the passive phase of the supply circuit, the supply control signal remains at a quiescent value (e.g., digital “LOW”), and the first converter switch maintains a specified state, in particular its blocking state. The supply control signal can directly be used to actuate the first converter switch.

The supply controller can be operated in a first power mode. In this first power mode, the supply control signal for the supply circuit is adjusted or produced depending on the dimming control signal. The dimming control signal indicates how much electrical power to the at least one illuminant is required. Depending on that, the supply control signal is adjusted so that the intermediate circuit voltage remains within a specified voltage range and does not exceed a maximum intermediate circuit voltage and does not fall below a minimum intermediate circuit voltage.

For example, a specified voltage range can also be a setpoint around which the intermediate circuit voltage value can and may fluctuate within a certain tolerance range. The fluctuations in the actual intermediate circuit voltage value can arise because of the latency of the open-loop or closed-loop controller of the intermediate circuit voltage and/or because of the so-called “ripple” due to the network alternating voltage.

An essentially constant intermediate circuit voltage within the specified voltage range avoids flickering of the at least one illuminant. Nevertheless, the converter frequencies for the converter circuits can be specified independently of one another and independently of the dimming frequency of the dimming control signal. Ideally, the intermediate circuit voltage is controlled, by open-loop or closed-loop control, in such a way that it corresponds to a set-point voltage.

In one sample embodiment it is possible to measure the intermediate circuit voltage and send it to the supply controller. The supply control signal can additionally depend on the recorded voltage value of the intermediate circuit voltage.

The dimmer controller and the supply controller can be designed as separate controllers or be integrated in a common controller.

The supply controller can preferably be operated in a second power mode. In this second power mode, the supply control signal is determined independently of the dimming control signal and output to the supply control circuit. In one sample embodiment, a power threshold can be specified for an electrical power, the supply controller working in the first power mode below this power threshold and working in the second power mode at or above the power threshold.

It is preferred if the supply controller adjusts the supply control signal in the first power mode depending on the dimming control signal in such a way that the electrical energy transported into the intermediate circuit during an active phase of the supply circuit corresponds to the electrical energy taken out of the intermediate circuit during an active phase of the power stage. Equalizing the energy balance in this way keeps the mean energy stored in the energy storage of the intermediate circuit constant over multiple cycles or active and passive phases in a period of time that is considered, so that the intermediate circuit voltage remains in the specified voltage range.

In one sample embodiment, the pulse-width modulated dimming control signal can directly actuate a dimmer switch that is connected in series with the at least one illuminant. In another sample embodiment, the dimming control signal can be used to actuate a second converter switch of the second converter circuit. When the second converter switch is actuated taking into consideration the dimming control signal, the converter switch is, for the duration of the active phase of the power stage specified by the dimming control signal, alternately switched over, at a second converter frequency, between a blocking and a conducting state, and it is kept in the blocking state for the duration of the passive phase of the power stage specified by the dimming control signal.

The second converter frequency is preferably greater than the dimming frequency, e.g., by a factor of 30. The first and the second converter frequencies can be the same or different. In one sample embodiment, the converter frequencies and the dimming frequency can each be constant.

When the dimmer switch is actuated with the help of the dimming control signal, the dimmer switch is in a conducting state during the active phase of the power stage and in a blocking state during the passive phase of the power stage.

It is preferred if the time duration of the active phase of the power stage and the time duration of the active phase of the supply circuit are of equal length. This contributes to keeping the intermediate circuit voltage in the specified voltage range, in particular to keeping it essentially constant.

In one sample embodiment of the operating circuit, the active phase of the power stage and the active phase of the supply circuit begin at the same time. The feeding of energy into the intermediate circuit and the removal of energy from the intermediate circuit take place simultaneously.

It is also possible to have the active phase of the power stage and the active phase of the supply circuit begin offset in time to one another. For example, the active phase of the power stage can take place during the passive phase of the supply circuit or the active phase of the supply circuit can take place during the passive phase of the power stage. In this embodiment, the feeding of energy into the intermediate circuit and the removal of energy from the intermediate circuit is offset in time.

It is also preferred for a duty cycle of the supply control signal and a duty cycle of the dimming control signal to have the same magnitude.

### Advantageous Effects of Invention

The operating circuit and the method for operating illuminants according to the present invention make it simple to avoid the flickering of the illuminants.

### BRIEF DESCRIPTION OF DRAWINGS

Advantageous embodiments of the invention follow from the dependent claims and the description. Following that, preferred sample embodiments of the invention are explained in detail using the attached drawings. The figures are as follows:

FIG. 1 is a block diagram of a sample embodiment of an operating circuit;

FIG. 2 is a block diagram of another sample embodiment of an operating circuit;

FIG. 3 is a circuit diagram of a sample embodiment of an operating circuit;

FIG. 4 is a circuit diagram of another sample embodiment of an operating circuit;

FIG. 5 is a schematic illustration of the principle of the time behavior of an intermediate circuit voltage and a supply control signal when the supply circuit of the operating circuit operates intermittently according to the prior art;

FIG. 6 is a schematic illustration of the principle of the time behavior of a dimming control signal, a converter control signal, an effective dimming control signal, a supply control signal VS, and an intermediate circuit voltage in one sample embodiment of the invention;

FIG. 7 is a schematic illustration of the principle of an example of the time behavior of an effective dimming control signal, a supply control signal, and an intermediate circuit voltage in one sample embodiment of the invention.

### DESCRIPTION OF EMBODIMENTS

FIG. 1 schematically illustrates a block diagram of an operating circuit 10 according to a sample embodiment. The operating circuit 10 has a supply circuit 11, whose input 12 is connected with a supply voltage UV. The supply voltage UV can be, for example, a rectified line voltage. The input 12 of the supply circuit 11 can be connected with an alternating voltage network, for example through a rectifier and a filter.

An output 13 of the supply circuit 11 has an intermediate circuit 14 with an energy storage 15 connected to it. The supply circuit 11 provides electrical energy for the intermediate circuit 14. In the sample embodiment, the energy storage 15 is in the form of a capacitor, in particular an electrolytic capacitor.

The operating circuit 10 also has a power stage 16. An input 17 of the power stage 16 is connected to the intermediate circuit 14. The intermediate circuit 14 supplies electrical energy to the power stage 16. The intermediate circuit voltage UZ is applied to the input 17 of the power stage 16.

An output 18 of the power stage 16 has an illuminant arrangement 19 with at least one illuminant 20 connected to it. In particular, the illuminant 20 can be a semiconductor illuminant, for example a light-emitting diode. The illuminants 20 can be connected with one another in series and/or in parallel. The power stage 16 provides the illuminant arrangement 19 with electrical energy corresponding to a requested lighting power.

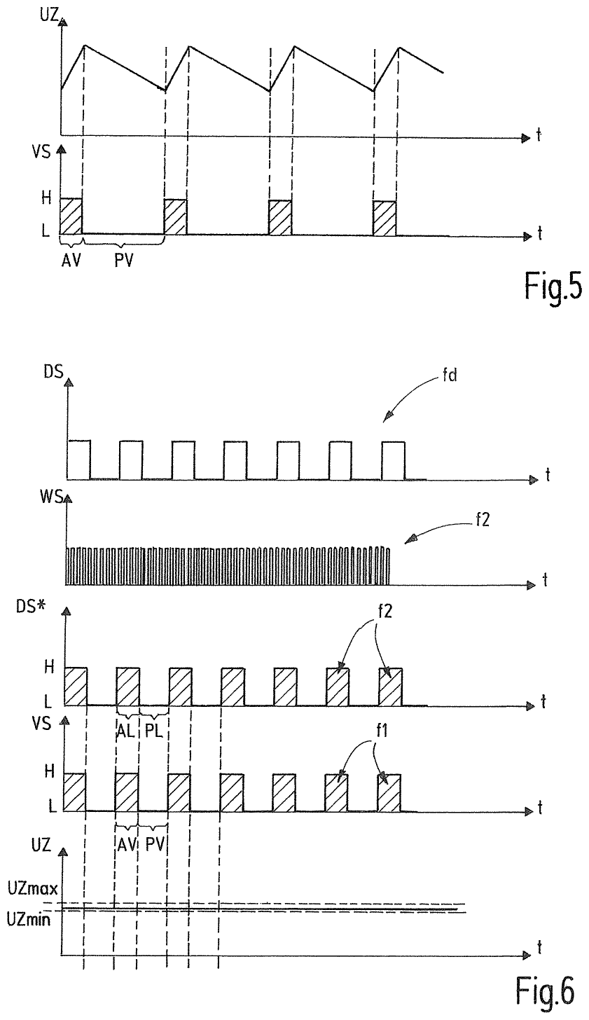

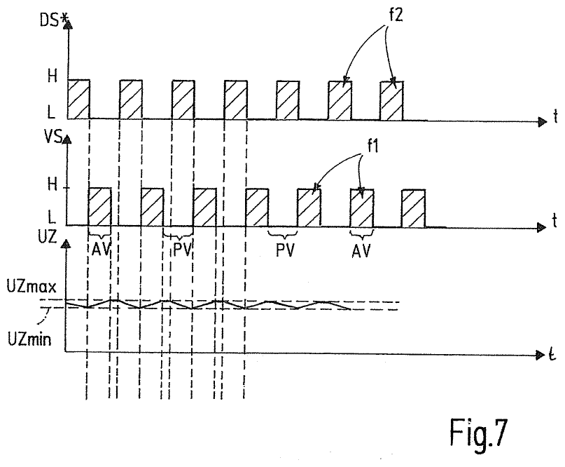

The operating circuit 10 also includes a controller 21. The controller 21 controls both the power stage 16, and also the supply circuit 11. The controller 21 controls the feeding of electrical power or energy into the intermediate circuit 14 by means of the supply circuit 11 and the removal of electrical power or energy from the intermediate circuit 14 by means of the power stage 16. Both the feeding in and the removal of electrical energy into or out of the intermediate circuit 14 is specified by the controller 21. This involves actuating the supply circuit 11 and the power stage 16 so that the lighting power of the illuminant arrangement 19 corresponds to the specification of the dimming input signal DE and electrical energy is fed into the intermediate circuit 14 by means of the supply circuit 11 so that the intermediate circuit voltage UZ remains in a specified voltage range that is defined by a minimum intermediate circuit voltage UZmin and a maximum intermediate circuit voltage UZmax (FIGS. 6 and 7).

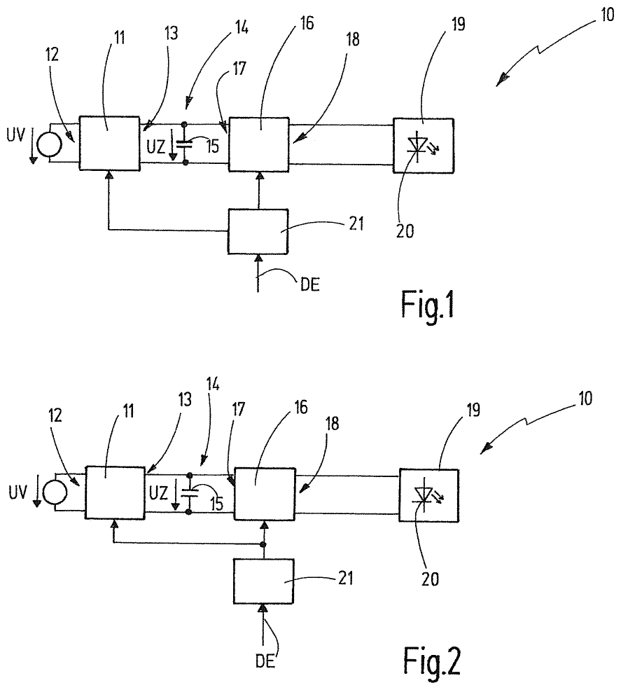

The controller 21 can produce separate actuation signals for the supply circuit 11 and the power stage 16 (FIG. 1). Alternatively, it is also possible to use the same control signal both to actuate the supply circuit 11 and also to actuate the power stage 16 (FIG. 2).

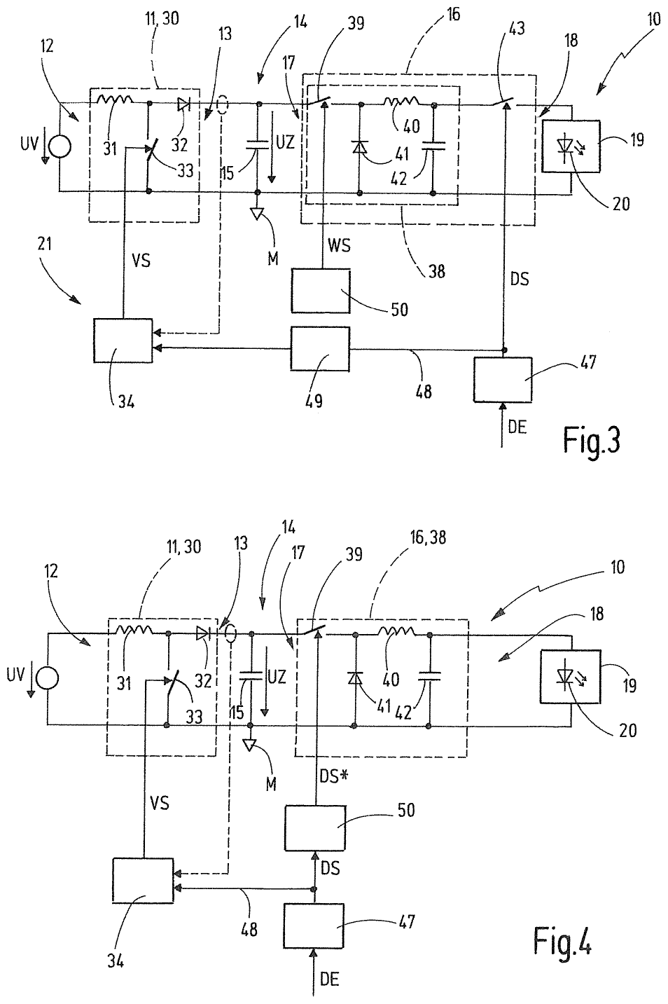

FIG. 3 illustrates a sample embodiment of an operating circuit 10. The supply circuit 11 is in the form of a first converter circuit 30. In the sample embodiment, the first converter circuit 30 is in the form of a step-up converter that can be set up and correspondingly controlled to carry out a power factor correction (PFC).

The first converter circuit 30 in the form of the up converter used here has a series circuit made of an inductance 31 and a converter diode 32. The series circuit is connected, through the inductance 31, with a terminal of the input 12, and through the cathode of the converter diode 32 with a terminal of the output 13. The connection point between the inductance 31 and the converter diode 32 is connected, through an actuable first converter switch 33, with the respective other terminal of the input 12 and the respective other terminal of the output 13, which are at the lower potential, according to the example ground potential M.

The controller 21 has a supply controller 34, which produces a supply control signal VS to actuate the first converter switch 33. The supply control signal VS is a pulse-width modulated signal.

The power stage 16 has a second converter circuit 38. In the sample embodiment, the second converter circuit 38 is designed without galvanic separation and is implemented as a step-down converter. The positive intermediate circuit potential applied to the input 17 is connected with an actuable second converter switch 39. The second converter switch 39 is connected in series with an inductance 40. The connection point between the inductance 40 and the second converter switch 39 is connected with the ground potential M through a converter diode 41 whose anode is associated with the ground potential M. The output of the second converter circuit 38 has an output capacitor 42 connected in parallel to it. One side of the output capacitor 42 is connected with the ground potential M and the other side is connected with the inductance 40 of the second converter circuit 38.

An output 18 of the power stage 16 has the illuminant arrangement 19 connected to it. The illuminant arrangement 19 is connected in series with a dimmer switch 43 of the power stage 16. The dimmer switch 43 can be connected before—in the current flow direction—the illuminant arrangement 19 or after the illuminant arrangement 19 and the second converter circuit 38.

A dimmer controller 47 of the controller 21 produces a dimming control signal DS to actuate the actuable dimmer switch 43. The dimming control signal DS is produced depending on the dimming input signal DE that is sent to the dimmer controller 47. The dimming control signal DS is also sent to the supply controller 34 through a coupling branch 48. This coupling branch 48 can have a signal matching unit 49 arranged in it to condition the dimming control signal DS for further processing by the supply controller 34. The signal matching unit 49 is optional and can also be omitted. It is preferable for the time response of the dimming control signal DS to remain unchanged by the signal matching unit 49.

To actuate the second converter switch 39, the controller 21 in the sample embodiment according to FIG. 3 has a separate converter controller 50. This converter controller 50 produces a converter control signal WS for the actuable second converter switch 39.

Each of the converter circuits 30, 38 can also realized by other converter topologies, for example by flyback converters, inverse converters, SEPIC converters, etc. In the sample embodiment, the first converter circuit 30 is designed without galvanic separation from the intermediate circuit 14.

The first converter circuit 30 works in different operating modes, depending on the electric power that it must provide at the output 13 of the supply circuit 11. In a so-called “discontinuous mode” or intermittent operating mode, relatively large variations can occur in the intermediate circuit voltage UZ, as is schematically illustrated in FIG. 5. During an active phase AV of the supply circuit 11, the first converter circuit 30 of the supply circuit is operated and electrical energy is fed into the intermediate circuit 14. During a passive phase PV of the supply circuit 11 the feeding of electrical energy into the intermediate circuit 14 is interrupted. This can produce the fluctuations in the intermediate circuit voltage UZ that are schematically illustrated in FIG. 5. The duration of the variation in these fluctuations is relatively long, that is the variation frequency is relatively low, below 100 Hz, which can produce perceptible flickering of the illuminants.

In the schematic representations of FIGS. 5-7, the value “H” of a signal in question VS, DS, DS*, WS designates that the actuated switch in question is in the conducting state, while the value “L” of the signal designates that the respective actuated switch is in its blocking state. The cross hatching during the active phases should be understood to mean that the signal or the actuated switch in question is in active operation and changes its signal state or switching state at the indicated frequency and an adjusted duty cycle. Here it should be pointed out that the representation in the figures is not true to scale, and the second converter frequency f2 can be greater in relation to the dimming control frequency fd than is shown in FIG. 6. Moreover, the rise or fall of the intermediate circuit voltage UZ shown in FIG. 5 can also exhibit nonlinear behavior, e.g., approximately exponential during an associated capacitor charging process or capacitor discharging process.

The operation of the sample embodiment according to FIG. 3 is explained below using FIG. 6.

Actuation of the first converter switch 33 by means of the supply control signal VS produces, from the supply voltage UV, the intermediate circuit voltage UZ, which is provided to the power stage 16. The pulse-width modulated supply control signal VS has a specified duty cycle and works with a first converter frequency f1.

The converter controller 50 produces a converter control signal WS that actuates the second converter switch 39, causing the second converter circuit 38 to provide, at its output, electric power for the illuminant arrangement 19, this electric power preferably having a constant output current. The pulse-width modulated converter control signal WS has a specified duty cycle and works with a second converter frequency f2.

The dimming control signal DS of the dimmer controller 47 is pulse-width modulated. The duty cycle of the dimming control signal DS determines the mean current through the illuminant arrangement 19 or the mean electric power to the illuminant arrangement 19, and consequently the lighting power or the brightness. The dimming frequency fd of the dimming control signal DS is clearly greater than 100 Hz and substantially less than that of the converter frequencies f1, f2.

In order to avoid voltage fluctuations of the intermediate circuit voltage UZ, the invention coordinates the feeding of electric power into and removal of electric power from the intermediate circuit 14 in at least one first power mode of the supply circuit 11. In the first power mode, the electric power provided for the intermediate circuit 14 is below a specified power threshold. The power threshold can be specified in the supply controller 34. It is also possible to measure or to determine the intermediate circuit voltage UZ and to send it to the supply controller 34 (illustrated in FIGS. 3 and 4 by a dashed line). Instead of a fixed specified power threshold, the switch over can be done in the first power mode if the intermediate circuit voltage UZ leaves the specified voltage range and consequently exceeds a maximum intermediate circuit voltage UZmax or falls below a minimum intermediate circuit voltage UZmin.

The supply control circuit 34 produces the supply control signal VS depending on the dimming control signal DS produced by the dimmer controller 47 at least when the supply control circuit 11 is in a first power mode. On the basis of the dimming control signal DS, the supply controller 34 can determine how much electrical energy is required for the requested lighting activity of the illuminant arrangement 19. Accordingly, the same electrical energy can be fed into the intermediate circuit 14 at the same time or offset in time. Equalizing the energy balance can keep the intermediate circuit voltage UZ at least essentially constant.

As is shown in FIG. 6, the dimming control signal DS switches to actuate the dimmer switch 43 with the dimming signal frequency fd in a duty cycle specified according to the dimming level. The second converter switch 39 will connect the converter switch signal DS with the second converter frequency f2. Connecting the second converter switch 39 and the dimmer switch 43 in series produces an effective dimming control signal DS*. During an active phase AL of the power stage 16, a mean current flow with the second converter frequency f2 is allowed through the illuminant arrangement 19. During a passive phase PL of the power stage 16, the current flow through the illuminant arrangement 19 is prevented. The high-frequency switch-over during the active phase AL is symbolized by the cross hatching.

In the first power mode, the first converter switch or the supply circuit 11 is actuated so that during an active phase AV of the supply circuit 11 the first converter switch 33 is switched over, at a first converter frequency f1, between its conducting and its blocking state to feed electrical energy into the intermediate circuit 14. During a passive phase PV of the first supply circuit 11, the first converter switch 33 is not switched over and remains, for example, in its blocking state.

In the sample embodiment illustrated in FIG. 6, the active phases AL, AV of the power stage 16 and [that of] the supply circuit 11 are of the same size and begin and end at the same time. This allows the quantity of electrical energy that is fed into the intermediate circuit 14 during an active phase AV of the supply circuit 11 and the quantity of electrical energy that is removed from the intermediate circuit 14 during an active phase AL of the power stage 16 to be of essentially the same size, so that the intermediate circuit voltage UZ remains essentially constant.

In a second power mode above the power threshold, the supply circuit 11 can be operated independently of the dimming level or dimming signal and independently of the power stage 16. In the second power mode, no intermittent operation of the first converter circuit 30 of the supply circuit 11 takes place or the time duration of the alternating active and passive phases is short, so that the fluctuations of the intermediate circuit voltage UZ are sufficiently small. Coordinated operation of the supply circuit 11 and the power stage 16 can involve disadvantages with regard to electromagnetic compatibility and the production of harmonics, so it is advantageous to limit the controller of the supply circuit 11 to a low-power range (first power mode), depending on the dimming signal DS.

The power threshold can be specified not only by the dimmer controller 47, but also in an alternative or additional way. It is possible for the dimming signal DS to be sent to the supply circuit 11 only in the first power mode, and not in the second power mode.

FIG. 4 illustrates a modified sample embodiment. The essential difference is that the separate dimmer switch 43 is eliminated and the power stage 16 is formed by the second converter circuit 38. The converter switch 39 is no longer actuated by the converter control signal WS, but rather by the effective dimming control signal DS* that is formed by combining, or performing an AND operation on, the dimming control signal DS and the converter control signal WS. To accomplish this, the dimming control signal DS is sent to the converter controller 50, which uses it, in combination with the internally specified converter control signal WS, to form the effective dimming control signal DS*. In other respects, the sample embodiment of FIG. 4 corresponds to the sample embodiment of FIG. 3. The mode of operation is essentially the same, so that it is possible to refer to the previous explanations.

FIG. 7 illustrates a modified controller of the supply circuit 11 and the power stage 16. The active phase AL of the power stage 16 and the active phase AV of the supply circuit 11 are offset in time. According to the example, the active phase AL of the power stage 16 takes place during the passive phase PV of the supply circuit 11, and conversely the active phase AV of the supply circuit 11 takes place during the passive phase PL of the power stage 16. This temporally separates the feeding of electrical energy into the intermediate circuit 14 and the removal of electrical energy from the intermediate circuit 14. The actuation illustrated in FIG. 7 can be used both in the sample embodiment according to FIG. 3 and in the sample embodiment according to FIG. 4.

In another sample embodiment, the active phases AL, AV of the power stage 16 and the supply circuit 11 could also partially overlap in time.

The invention relates to an operating circuit 10 and a method for operating at least one illuminant 20, according to the example at least one light-emitting diode. The operating circuit 10 has a supply circuit 11 that is connected to a supply voltage UV and that has a first converter circuit 30. The supply circuit 11 is connected to a power stage 16 through an intermediate circuit 14 with an energy storage 15 to buffer an intermediate circuit voltage UZ. The power stage 16 has a second converter circuit 38. The output side of the power stage 16 has the at least one illuminant 20 connected to it. A desired dimming level is specified through a dimming input signal DE. Depending on the dimming input signal DE, the power stage 16 is actuated by means of a dimming control signal DS to adjust the lighting power. The dimming control signal DS or a signal characterizing the dimming control signal DS is taken into consideration in the controller of the supply circuit 11, to keep the intermediate circuit voltage UZ within a specified voltage range.

### REFERENCE SIGNS LIST

10 Operating circuit
11 Supply circuit
12 Input of supply circuit
13 Output of supply circuit
14 Intermediate circuit
15 Energy storage
16 Power stage
17 Input of power stage
18 Output of power stage
19 Illuminant arrangement
20 Illuminant
21 Controller
30 First converter circuit
31 Inductance
32 Converter diode
33 First converter switch
34 Supply controller
38 Second converter circuit
39 Second converter switch
40 Inductance
41 Converter diode
42 Output capacitor
43 Dimmer switch
47 Dimmer controller
48 Coupling branch
49 Signal matching unit
50 Converter controller
DE Dimming input signal
DS Dimming control signal
DS* Effective dimming control signal
f1 First converter frequency
f2 Second converter frequency
fd Dimming frequency
M Ground potential
UV Supply voltage
UZ Intermediate circuit voltage
UZmax Maximum intermediate circuit voltage
UZmin Minimum intermediate circuit voltage
VS Supply control signal
WS Converter control signal

1. An operating circuit for operating at least one illuminant, comprising:
a supply circuit that has an input for connection to a supply voltage and an actuable first converter circuit;
an intermediate circuit having an energy storage, the intermediate circuit being connected to an output of the supply circuit and having an intermediate circuit voltage applied to it;
a power stage that has an input connected to the intermediate circuit and an output connected to the at least one illuminant, and that has an actuable second converter circuit;
a dimmer controller to which a dimming input signal is sent and which is configured to adjust the lighting power of the at least one illuminant based on the dimming input signal by producing a pulse-width modulated dimming control signal with a dimming frequency for the power stage, the dimming control signal defining an active phase of the power stage and a passive phase of the power stage; and
a supply controller to which the dimming control signal is sent and which is configured to adjust the power output to the intermediate circuit during an active phase of the supply circuit by producing a pulse-width modulated supply control signal with a first converter frequency for the first converter circuit, the first converter frequency being independent of the dimming frequency, and by keeping the supply control signal at a quiescent value during a passive phase of the supply circuit,
wherein the supply controller adjusts the supply control signal in a first power mode depending on the dimming control signal so that the intermediate circuit voltage remains within a specified voltage range.

2. The operating circuit according to claim 1,
wherein the supply controller adjusts the supply control signal in a second power mode independently of the dimming control signal.

3. The operating circuit according to claim 1,
wherein a power threshold for an electric power is set, the supply controller working in the first power mode below the power threshold.

4. The operating circuit according to claim 3,
wherein the supply controller works in the second power mode above the power threshold.

5. The operating circuit according to claim 1,
wherein the supply controller adjusts the supply control signal depending on the dimming control signal, so that the energy fed into the intermediate circuit during an active phase of the supply circuit corresponds to the energy removed from the intermediate circuit during an active phase of the power stage.

6. The operating circuit according to claim 1,
wherein the dimming control signal actuates the dimmer switch and/or is used for actuation of a second converter switch of the second converter circuit.

7. The operating circuit according to claim 6,
wherein the dimming control signal keeps the dimmer switch in a conducting state during the active phase of the power stage and keeps it in the blocking state during the passive phase of the power stage.

8. The operating circuit according to claim 6,
wherein the dimming control signal alternately switches over, at a second converter frequency, the second converter switch between a blocking and a conducting state during the active phase of the power stage, and keeps it in the blocking state during the passive phase of the power stage.

9. The operating circuit according to claim 1,
wherein the time duration of the active phase of the power stage and the time duration of the active phase of the supply circuit are of equal length.

10. The operating circuit according to claim 1,
wherein the active phase of the power stage and the active phase of the supply circuit begin at the same time.

11. The operating circuit according to claim 1,
wherein the active phase of the power stage and the active phase of the supply circuit begin offset in time.

12. The operating circuit according to claim 11,
wherein the active phase of the power stage takes place during the passive phase of the supply circuit.

13. The operating circuit according to claim 11,
wherein the active phase of the supply circuit takes place during the passive phase of the power stage.

14. The operating circuit according to claim 1,
wherein a first duty cycle of the supply control signal and a second duty cycle of the dimming control signal have the same magnitude.

15. A method for operating at least one illuminant using an operating circuit including: a supply circuit that is connected, at an input, to a supply voltage and that has an actuable first converter circuit; an intermediate circuit having an energy storage, the intermediate circuit being connected to an output of the supply circuit and having an intermediate circuit voltage applied to it; a power stage that has an input connected to the intermediate circuit and an output connected to at least one illuminant, and that has an actuable second converter circuit; a dimmer controller to which a dimming input signal is sent; and a supply controller, the method comprising:
producing a pulse-width modulated dimming control signal with a dimming frequency for the power stage depending on the dimming input signal to adjust the lighting power of the at least one illuminant, the dimming control signal defining an active phase of the power stage and a passive phase of the power stage;
producing a pulse-width modulated supply control signal to adjust the power output to the intermediate circuit with a first converter frequency independent of the dimming frequency for the first converter circuit during an active phase of the supply circuit and keeping the supply control signal at a quiescent value during a passive phase of the supply circuit, the supply control signal being dependent on the dimming control signal in a first power mode so that the intermediate circuit voltage remains within a specified voltage range.
